(19) United States
(12) Patent Application Publication
(10) Pub. No.: US 2012/0106861 A1
(43) Pub. Date: May 3, 2012

(54) IMAGE COMPRESSION METHOD

(75) Inventors: Chia-Ho Pan, Tainan City (TW); Ching-Yen Chang, Hsinchu City (TW); Che-Wei Chang, Taipei City (TW); Shuei-Lin Chen, Kaohsiung City (TW)

(73) Assignee: ALTEK CORPORATION, Hsinchu (TW)

(21) Appl. No.: 13/176,171

(22) Filed: Jul. 5, 2011

(30) Foreign Application Priority Data
Oct. 29, 2010 (TW) 099137336

(51) Int. Cl. G06K 9/36

(52) U.S. Cl. 382/232

(57) ABSTRACT

A compressing method is applicable to compress of an image at a fixed compression ratio, in which the image has a raw data. The compression method includes the steps of receiving the raw data with a predetermined length as a compression unit; compressing the compression unit into a compressed bit stream, wherein a total length of the compressed bit stream being not larger than a target bit stream length; when the total length of the compressed bit stream is smaller than the target bit stream length, appending a dummy code to the compressed bit stream, so that a bit stream length of the compressed bit stream with the dummy code is equal to the target bit stream length; and repeating steps until the raw data is compressed into an image bit stream.

### CROSS-REFERENCE TO RELATED APPLICATIONS

This non-provisional application claims priority under 35 U.S.C. §119(a) on Patent Application No(s). 099137336 filed in Taiwan, R.O.C. on Oct. 29, 2010, the entire contents of which are hereby incorporated by reference.

### BACKGROUND OF THE INVENTION

1. Field of Invention

The present invention relates to an image compression method, and more particularly to an image compression method with a fixed compression ratio for a raw data of a digital image.

2. Related Art

A user can capture an image or a video with a digital camera or a video camera. However, data initially obtained by a sensor of a camera is raw data, and the raw data cannot be provided to the user for viewing before many signal processing operations.

However, the raw data of the image usually needs to occupy a large storage space, so Pentax, Nikon and Canon provide digital single lens reflex camera (DSLR) products that compress a raw data of an image, so as to save the storage space and read/write time. However, in existing raw data compression technologies, lossless compression or invisible lossy compression are mostly adopted, and in the methods, a file size after compression is difficult to be predicted and controlled. The space that can be saved by such compression methods is uncertain, and the amount of storage space saved can only be determined after practical compression. In other words, in the conventional compression methods, the saved space is dependent on respective compression, and a result of a fixed compression ratio cannot be obtained.

In terms of the memory space, since the conventional compression methods cannot know a compression ratio in advance or cannot maintain a fixed compression ratio, a maximum space still needs to be reserved on the memory, such that no improvement is achieved for the memory size.

### SUMMARY OF THE INVENTION

In order to solve the above problems, the present invention is an image compression method. The image compression method is applicable to compress of an image at a fixed compression ratio, in which the image has a raw data.

The image compression method comprises: receiving the raw data with a predetermined length as a compression unit; compressing the compression unit into a compressed bit stream, a total length of the compressed bit stream being not larger than a target bit stream length; when the total length of the compressed bit stream is smaller than the target bit stream length, appending a dummy code to the compressed bit stream, so that a bit stream length of the compressed bit stream with the dummy code is equal to the target bit stream length; and repeating all the steps, until the raw data is compressed into an image bit stream, in which the image bit stream comprises all the compressed bit streams and the individual dummy codes appended to the compressed bit streams.

The target bit stream length may be a product of the compression ratio and the bit stream length of the compression unit. The dummy code may have all bits with the same value, or may also include an appended verification code of the compressed bit stream, or include a special header for identifying that encoding is ended.

According to different embodiments of the present invention, the compression unit may be a compression window, a line, one or more image bands or a whole frame.

When the compression unit is the line, the step of compressing the compression unit into the compressed bit stream, the total length of the compressed bit stream being not larger than the target bit stream length may comprise: dividing the line by the compression window; compressing each compression window into a sub bit stream in sequence; and using the sub bit streams corresponding to the line as the compressed bit stream.

When the compression unit is the image band, the step of compressing the compression unit into the compressed bit stream, the total length of the compressed bit stream being not larger than the target bit stream length may comprise: dividing the image band by the compression window; compressing each compression window into the sub bit stream in sequence; and using the sub bit streams corresponding to the image band as the compressed bit stream.

Based on the above, the image compression method can ensure the size of the image bit stream. Also, with the dummy codes, the compressed bit streams can be arranged in order in the image bit stream, so that each compressed bit stream in the image bit stream can be easily selected, accessed, and decompressed.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a flow chart of an image compression method according to an embodiment of the present invention;

FIG. 2 is a schematic view of a codec to which an image compression method is applicable according to an embodiment of the present invention;

FIG. 3 is a schematic view of a compression unit according to an embodiment of the present invention;

FIG. 4A is a schematic view of an image bit stream according to an embodiment of the present invention;

FIG. 4B is a schematic view of an image bit stream according to another embodiment of the present invention;

FIG. 5A is a flow chart of Step S120 according to an embodiment of the present invention;

FIG. 5B is a flow chart of Step S120 according to another embodiment of the present invention; and

FIG. 6 is a flow chart of a decoding procedure according to an embodiment of the present invention.

### DETAILED DESCRIPTION OF THE INVENTION

The detailed features and advantages of the present invention are described below in detail through the following embodiments, and the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

The present invention provides an image compression method, which can be executed by an electronic device. The image compression method is applicable to compress of an image at a compression ratio into an image bit stream, in which the image has a raw data.

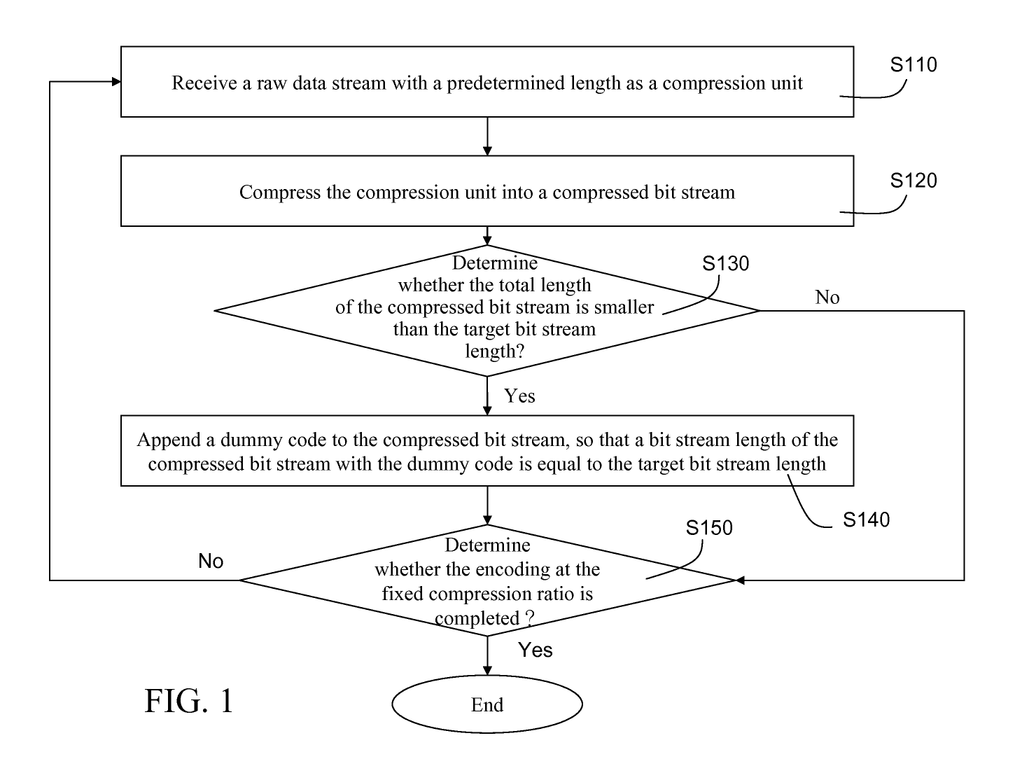

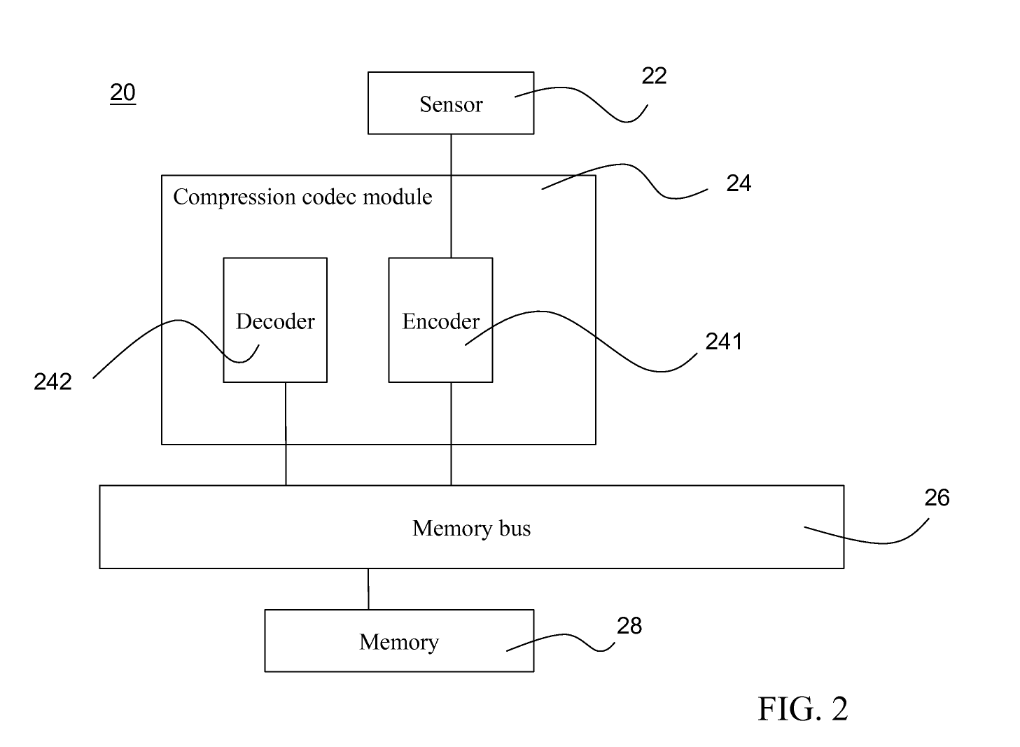

FIG. 1 is a flow chart of an image compression method according to an embodiment of the present invention and FIG. 2 is a schematic view of a codec to which the image compression method is applicable. As can be seen from FIG. 2, the electronic device 20 comprises a sensor 22, a compression codec module 24, a memory bus 26, and a memory 28. The compression codec module 24 comprises at least one encoder 241 or decoder 242, and may also comprise the encoder 241 and the decoder 242 at the same time.

The electronic device 20 may be a device capable of capturing the image with the sensor 22, such as a digital camera, a mobile phone with photography function, a notebook computer with photography function, or an image capturing module. The sensor 22 may be, for example, a charge coupled device (CCD) or a complementary metal oxide semiconductor (CMOS), which is used for generating a raw data of an image.

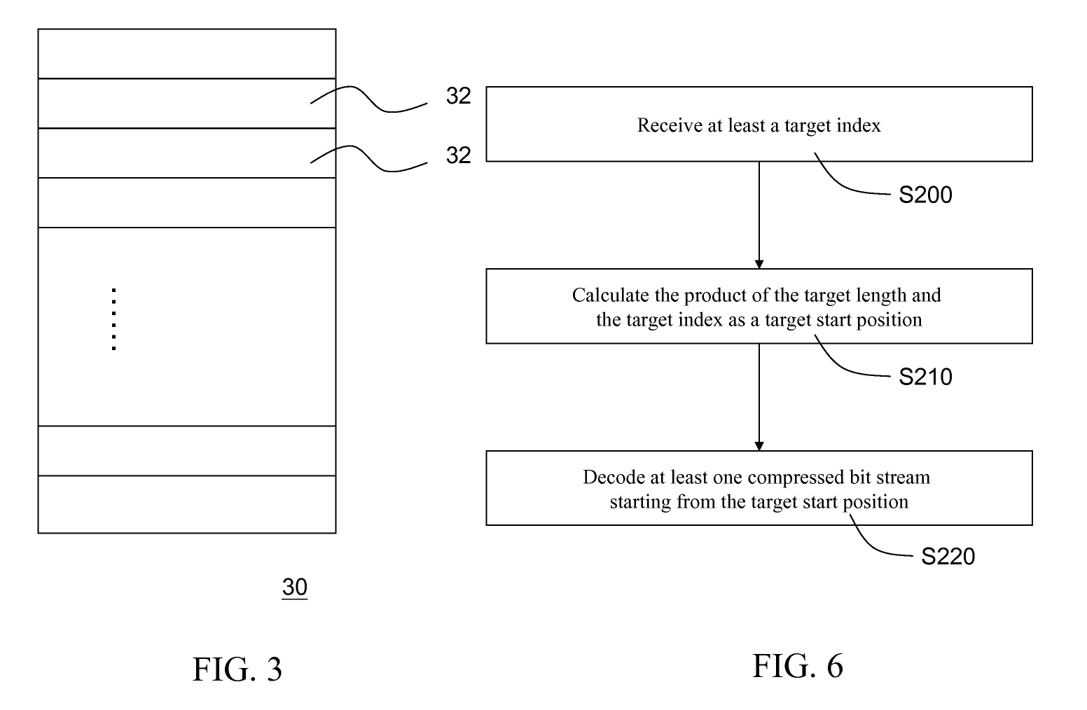

For the compression codec module 24, firstly, the sensor 22 receives the raw data of the image having a predetermined length as a compression unit (Step S110). FIG. 3 is a schematic view of a compression unit according to an embodiment of the present invention. The compression unit 32 is a part of a raw data 30 of a whole image, and for example, may be a line, an image band, a compression window or the whole frame. In the embodiment in FIG. 3, the image is divided into the plurality of lines, each line is a row of pixels in the image, and each line is used as one compression unit 32. The image band is also a unit for dividing the image, and the image band may comprise at least one of the lines. The compression window generally comprises a part of consecutive pixels in a line, for example, consecutive 8, 16 or 24 pixels in a line may be used as a compression window.

The encoder 241 compresses the compression unit 32 into a compressed bit stream at the fixed compression ratio (Step S120), in which a total length of the compressed bit stream is not larger than a target bit stream length, so as to ensure that the image bit stream obtained after compression can reach the preset compression ratio. The encoder 241 may try different compression parameters repetitively by using a common compression standard (for example, Joint photographic experts group (JPEG)), until the target bit stream length is reached through compression. Alternatively, the compression is performed through a proprietary compression method. According to an embodiment of the present invention, the target bit stream length may be a product of the compression ratio and a bit stream length of the compression unit 32.

For example, when the compression unit 32 is a compression window having 8 pixels, each pixel in the raw data 30 uses 8 bits, and the compression ratio is 1/2, the target bit stream length is 8×8×1/2=32 bits. Also, for example, when the bit stream length of the raw data 30 of the image is 80 megabytes (MB) and the compression ratio is 1/2, the bit stream length of the image bit stream is 80 MB×1/2=40 MB. According to another embodiment of the present invention, the encoder 241 only needs to keep the whole image bit stream obtained after compression below the compression ratio, and does not need to keep each compressed bit stream below the compression ratio.

The compression codec module 24 receives the compressed bit stream, and determines whether the total length of the compressed bit stream is smaller than the target bit stream length (S130). When the total length of the compressed bit stream is smaller than the target bit stream length, the compression codec module 24 appends a dummy code to the compressed bit stream, so that the bit stream length of the compressed bit stream with the dummy code is equal to the target bit stream length (S140).

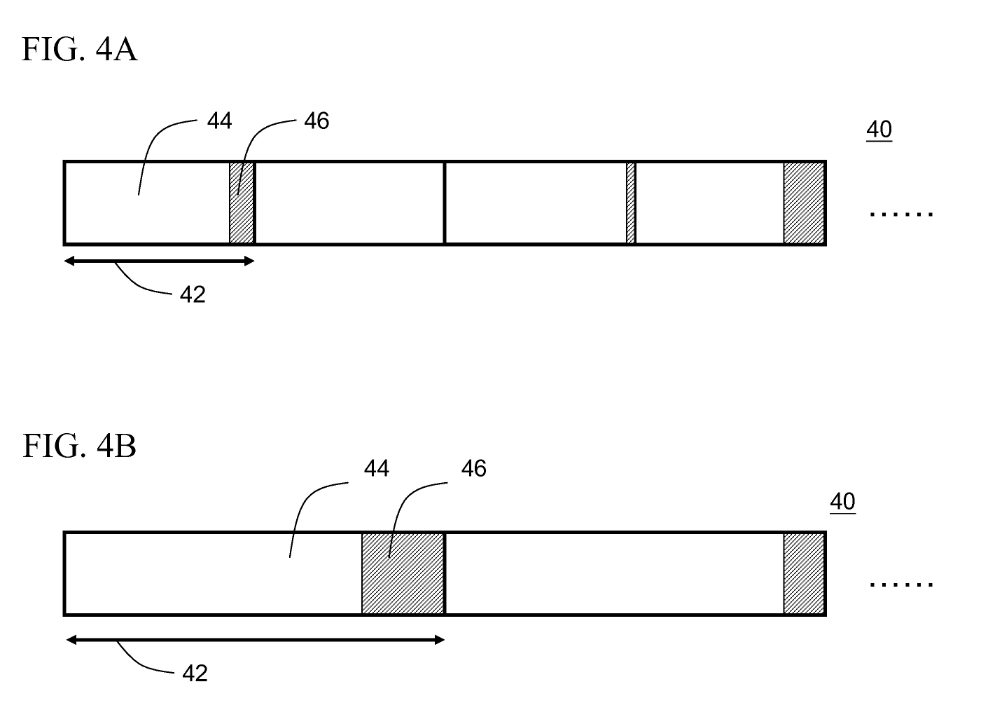

FIGS. 4A and 4B are schematic views of image bit streams according to different embodiments of the present invention, respectively. In the embodiments in FIGS. 4A and 4B, one line as one image band and two lines as one image band are respectively used as compression units for processing. The compression codec module 24 appends the dummy code 46 to the compressed bit stream 44 that does not reach the target bit stream length 42.

The image content affects the compression result of the compression unit 32. Thus, the length of the dummy code 46 corresponding to each compressed bit stream 44 may be different.

The dummy code 46 may have all bits with the same value, for example, all 0 or all 1. The dummy code 46 may also include an appended verification code of the compressed bit stream 44, for example, a check sum of the corresponding compressed bit stream 44, or include a special header for identifying that encoding is ended.

When the bit stream length of the compressed bit stream 44 is the same as the target bit stream length 42 or the compressed bit stream 44 is already appended with a suitable dummy code 46, the compression codec module 24 determines whether the compression of the whole raw data 30 into the image bit stream 40 is completed (S150). If the compression of the raw data 30 of the image is completed, the image compression method may be ended. If not, all Steps S110 to S150 are repeated, until the raw data 30 is compressed into the complete image bit stream 40. The complete image bit stream 40 comprises all the compressed bit streams 44 and the individual dummy codes 46 appended to the compressed bit streams 44.

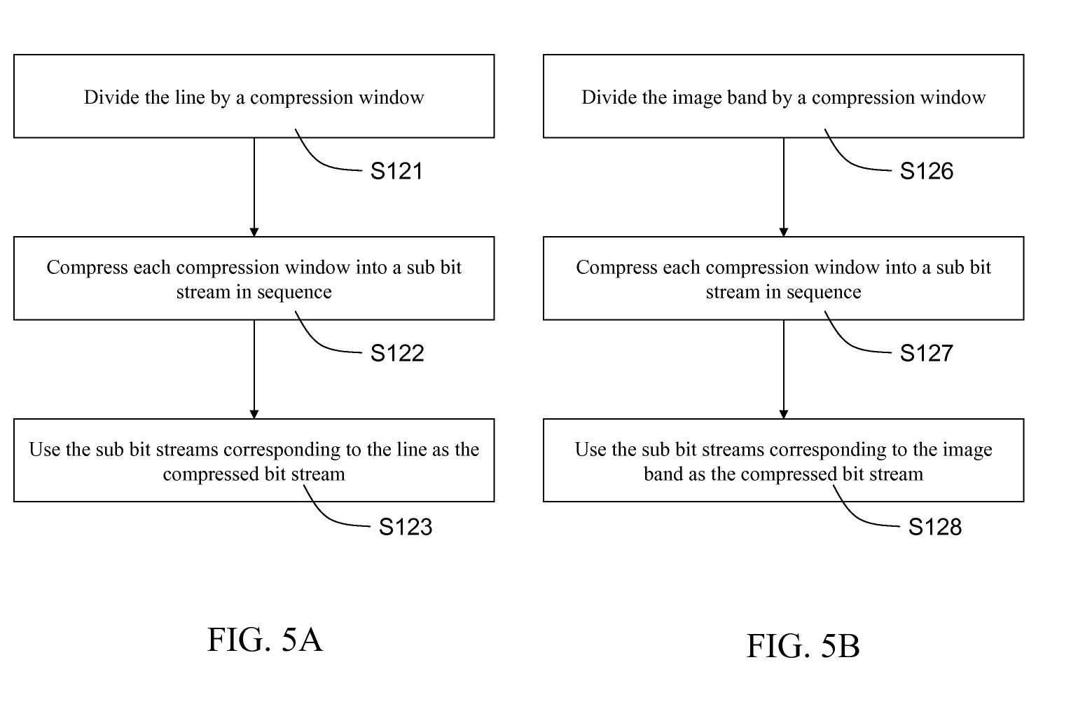

FIGS. 5A and 5B are flow charts of Step S120 according to different embodiments of the present invention, respectively. According to an embodiment of the present invention, when the compression unit 32 is a line, Step S120 may comprise: dividing the line by the compression window (Step S121); compressing each compression window into a sub bit stream in sequence (Step S122); and using the sub bit streams corresponding to the line as the compressed bit stream 44 (Step S123).

According to another embodiment of the present invention, when the compression unit 32 is an image band, Step S120 may comprise: dividing the image band by the compression window (Step S126); compressing each compression window into the sub bit stream in sequence (Step S127); and using the sub bit streams corresponding to the image band as the compressed bit stream 44 (Step S128). In other words, the encoder 241 may compress a part of the image of one compression window into the sub bit stream each time; and the compression codec module 24 then writes the dummy code 46 after comprising the plurality of compression windows as a unit.

The compression codec module 24 may further comprise at least one decoder 242. The decoder 242 executes a decoding procedure to decompress at least one of the compressed bit streams 44 in the image bit stream 40 back to the compression window, line or image band corresponding thereto. FIG. 6 is a flow chart of a decoding procedure according to an embodiment of the present invention.

The decoder 242 may firstly receive at least a target index (Step S200). The target index may be a number of each compressed bit stream 44. Next, the decoder 242 calculates the product of the target bit stream length 42 and the target index as a target start position (Step S210), and decodes at least one compressed bit stream 44 starting from the target start position (Step S220). As the start point of the compressed bit stream 44 exists following every target bit stream length 42 in the image bit stream 40, the decoder 242 can randomly access any compressed bit stream 44 in the image bit stream 40, and decompress the compressed bit stream 44.

Based on the above, the encoder compresses the raw data of the image at the fixed compression ratio, so as to ensure that the image bit stream obtained after compression can save sufficient storage space and memory access bandwidth. In addition, through the technology of appending dummy codes, each compressed bit stream in the image bit stream can be easily selected, accessed, and decompressed. Thus, when only a part of compression units in the whole image need to be decompressed, it only needs to decompress the compressed bit streams corresponding to the required compression units, instead of decompressing the whole image bit stream.

What is claimed is:

1. An image compression method, executed by an electronic device, and applicable to compress of an image at a compression ratio, wherein the image has a raw data, the image compression method comprising:
receiving the raw data with a predetermined length as a compression unit;
compressing the compression unit into a compressed bit stream, a total length of the compressed bit stream being not larger than a target bit stream length;
when the total length of the compressed bit stream is smaller than the target bit stream length, appending a dummy code to the compressed bit stream, so that a bit stream length of the compressed bit stream with the dummy code is equal to the target bit stream length; and
repeating all the steps, until the raw data is compressed into an image bit stream, wherein the image bit stream comprises all the compressed bit streams and the individual dummy codes appended to the compressed bit streams.

2. The image compression method according to claim 1, wherein the target bit stream length is a product of the compression ratio and a bit stream length of the compression unit.

3. The image compression method according to claim 1, wherein the compression unit is a compression window.

4. The image compression method according to claim 1, wherein the compression unit is a line.

5. The image compression method according to claim 4, wherein the step of compressing the compression unit into the compressed bit stream, the total length of the compressed bit stream being not larger than the target bit stream length comprises:
dividing the line by a compression window;
compressing each compression window into a sub bit stream in sequence; and
using the sub bit streams corresponding to the line as the compressed bit stream.

6. The image compression method according to claim 1, wherein the compression unit is an image band.

7. The image compression method according to claim 6, wherein the step of compressing the compression unit into the compressed bit stream, the total length of the compressed bit stream being not larger than the target bit stream length comprises:
dividing the image band by a compression window;
compressing each compression window into a sub bit stream in sequence; and
using the sub bit streams corresponding to the image band as the compressed bit stream.

8. The image compression method according to claim 1, wherein all bits in the dummy code have the same value.

9. The image compression method according to claim 1, wherein the dummy code includes an appended verification code of the compressed bit stream.

10. The image compression method according to claim 1, wherein the dummy code includes a special header for identifying that encoding is ended.
